(19) United States
(12) Patent Application Publication
(10) Pub. No.: US 2005/0223241 A1
(43) Pub. Date: Oct. 6, 2005

(54) Semiconductor intergrated circuit device, data storage verification device, and data storage verification method

(75) Inventors: Katsuhiro Nakai, Sanda-shi (JP); Tsuyoshi Nanba, Hirakata-shi (JP); Takehisa Hirano, Mino-shi (JP); Tomoaki Tezuka, Osaka-shi (JP)

Correspondence Address: WENDEROTH, LIND & PONACK, L.L.P., 2033 K STREET N. W., SUITE 800, WASHINGTON, DC, 20006-1021, US

(73) Assignee: Matsushita Electric Industrial Co. Ltd, Osaka 571-8501 (JP)

(21) Appl. No.: 10/517,258

(22) PCT Filed: Jun. 13, 2003
(86) PCT No.: PCT/JP03/07541

§ 371 Date: Dec. 7, 2004

(30) Foreign Application Priority Data
Jun. 14, 2002 (JP) 2002-174883

(51) Int. Cl. H04L 9/32

(52) U.S. Cl. 713/193

(57) ABSTRACT

There is provided a semiconductor integrated circuit device (100) for downloading a program of an arithmetic processing unit, such as a DSP or a CPU, from the outside, wherein a rewrite program as secret information not to be leaked to third parties, which is downloaded in a semiconductor integrated circuit (109), is checked as to whether it is correctly downloaded or not while maintaining the confidentiality of the rewrite program. The semiconductor integrated circuit device is provided with a circuit for verifying the contents of the downloaded rewrite program, and/or a program for verifying the contents of the downloaded rewrite program.

### TECHNICAL FIELD

The present invention relates to a semiconductor integrated circuit device, a data storage verification device, and a data storage verification method and, more particularly, to those capable of easily checking whether download can be reliably carried out while maintaining protection for a program as secret information the contents of which should not be leaked to third parties, i.e., while maintaining confidentiality of the program.

### BACKGROUND ART

In a semiconductor integrated circuit including an arithmetic processing unit such as a DSP (Digital Signal Processor) or a CPU, it is desired that a program of the arithmetic processing unit is stored in a ROM from the viewpoints of cost and protection of confidentiality of the program. However, if the program is stored in a non-rewritable means such as a ROM, it is difficult to flexibly deal with a change in specification or a defect of the program itself. There are cases where a means for storing a program into a semiconductor integrated circuit is implemented as a rewritable means such as a RAM from the viewpoint of facility in development of such circuit. In the circuit having the above-mentioned construction, it is necessary to previously download a program required for an arithmetic processing unit for controlling a signal processing apparatus, such as a DSP or a CPU, into a specific area in a rewritable RAM or the like. In this specification, “download” means loading of data or programs into a semiconductor integrated circuit.

However, the possibility of leakage of program contents to third parties is higher in a semiconductor integrated circuit which downloads a program of an arithmetic processing unit such as a DSP or a CPU from the outside into a RAM, than in a semiconductor integrated circuit which stores a program in an internal ROM.

For example, when a program for detecting a watermark (digital watermark) that is developed for copyright protection is stored outside the semiconductor integrated circuit, if the contents of the program is leaked to third parties with an evil intention, the mechanism for copyright protection might be invalidated, and therefore, the program itself should be protected.

In this case, it is considered that the program itself can be protected by previously encrypting the program to be downloaded into the semiconductor integrated circuit, and decrypting the encrypted program in the semiconductor integrated circuit.

However, it is difficult to check whether the program data which is downloaded into the rewritable area in the semiconductor integrated circuit, including the encrypted data and the non-encrypted data, are correctly stored or not, while maintaining the confidentiality.

The present invention is made to solve the above-mentioned problems and has for its object to provide a semiconductor integrated circuit device, a data storage verification device, and a data storage verification method, which are able to check whether download is correctly carried out or not without leaking program data requiring confidentiality to the outside.

### DISCLOSURE OF THE INVENTION

In order to solve the above-described problems, according to claim 1 of the present invention, there is provided a semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents; wherein the second storage means has an externally readable area that can be read from the outside of the semiconductor integrated circuit, and an externally unreadable area that cannot be read from the outside; and, after arbitrary data is stored in the externally readable area of the second storage means, the data is read to the outside of the semiconductor integrated circuit to check whether the arbitrary data is the data as inputted, and thereafter, the rewrite program read from the first storage means is stored in the externally unreadable area of the second storage means.

Thereby, it is possible to check whether the rewrite program is correctly stored in the semiconductor integrated circuit or not while maintaining the confidentiality of the rewrite program, by writing dummy data or the like into the readable area of the second storage means, and reading the written dummy data to check the same.

According to claim 2 of the present invention, there is provided a semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents, and the semiconductor integrated circuit device includes a control circuit for performing control so as to read only a specific portion of the rewrite program stored in the second storage means.

Thereby, it is possible to check whether the rewrite program is correctly downloaded in the semiconductor integrated circuit or not while maintaining the confidentiality of the rewrite program, by reading only a specific portion of the rewrite program stored in the second storage means, and verifying the specific portion.

According to claim 3 of the present invention, in the semiconductor integrated circuit device defined in claim 2, the control circuit performs control so as to read only the rewrite program located in specific addresses of the second storage means.

Thereby, it is possible to check whether the rewrite program is correctly downloaded in the semiconductor integrated circuit or not while maintaining the confidentiality of the rewrite program, by reading only specific addresses of the second storage means, and verifying data in the specific addresses.

According to claim 4 of the present invention, in the semiconductor integrated circuit device defined in claim 2, the control circuit performs control so as to read only specific bits of the rewrite program stored in the second storage means.

Thereby, it is possible to check whether the rewrite program is correctly downloaded in the semiconductor integrated circuit or not while maintaining the confidentiality of the rewrite program, by reading only specific bits of the second storage means, and verifying the specific bits.

According to claim 5 of the present invention, there is provided a semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents; wherein the rewrite program includes a program for executing a portion of the rewrite program after the rewriting; and the portion of the rewrite program stored in the second storage means is executed.

Thereby, it is possible to check whether the rewrite program as secret information not to be leaked to third parties is correctly downloaded in the semiconductor integrated circuit or not, while maintaining the confidentiality of the rewrite program.

According to claim 6 of the present invention, in the semiconductor integrated circuit device defined in claim 5, the portion of the rewrite program to be executed is one for successively executing discontinuous program areas.

Thereby, when, for example, a head program and a final program of the rewrite program stored in the second storage means are executed, it is possible to check whether the rewrite program is correctly stored up to the end or not, while maintaining the confidentiality of the rewrite program.

According to claim 7 of the present invention, there is provided a semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents; and the semiconductor integrated circuit device includes, in the semiconductor integrated circuit, a transfer monitor means for monitoring the rewrite program to be transferred from the first storage means to the second storage means.

Thereby, it is possible to check whether the rewrite program as secret information not to be leaked to third parties is correctly downloaded in the semiconductor integrated circuit or not, while maintaining the confidentiality of the rewrite program.

According to claim 8 of the present invention, there is provided a semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents; wherein the rewrite program includes a check program for checking whether the program is correct or not; the semiconductor integrated circuit is provided with a work memory for the arithmetic processing unit, and a connection switching means for switching the connection between the second storage means or the work memory, and the program input or the data input of the arithmetic processing unit; and the check program that is extracted from the rewrite program stored in the second storage means is stored in the work memory, and the arithmetic processing unit is operated by the check program stored in the work memory, thereby to check whether the rewrite program is correct or not.

Thereby, the program input or the data input to the arithmetic processing unit can be changed by the connection switching means to capture the data of the rewrite program, and a checksum or the like of the rewrite program data can be obtained and compared with a predetermined value. Therefore, it is possible to check whether the rewrite program as secret information not to be leaked to third parties is correctly downloaded in the semiconductor integrated circuit or not, while maintaining the confidentiality of the rewrite program.

According to claim 9 of the present invention, in the semiconductor integrated circuit device defined in claim 8, the second storage means holds the rewrite program, and holds data which is uniquely obtained from a predetermined cluster in the rewrite program, according to a predetermined rule.

Thereby, it is possible to check whether the rewrite program as secret information not to be leaked to third parties is correctly downloaded in the semiconductor integrated circuit or not, while maintaining the confidentiality of the rewrite program. Further, when the rewrite program is not correctly stored in the second storage means, information of a position where the rewrite program is not correctly stored can be obtained.

According to claim 10 of the present invention, in the semiconductor integrated circuit device defined in claim 9, the uniquely obtained data is used as a check code for checking whether the program is correct or not.

Thereby, it is possible to check whether the rewrite program as secret information not to be leaked to third parties is correctly downloaded in the semiconductor integrated circuit or not, while maintaining the confidentiality of the rewrite program. Further, when the rewrite program is not correctly stored in the second storage means, information of a position where the rewrite program is not correctly stored can be obtained.

According to claim 11 of the present invention, in the semiconductor integrated circuit device defined in claim 8, the second storage means has a construction in which an area where the rewrite program is not stored is successively divided into two areas, and the same program is stored in each of the two areas; the check program includes a program for comparing the program data stored in one of the two areas with the same data stored in the other area, thereby to check whether the program data is correct or not, and a program for, when the result of the previous check is that the program data is correct, repeating an operation of further dividing one of the two areas, as an area wherein no program is stored, into two areas, and storing the same program data in each of the two areas; and all of the programs to be stored in the second storage means are successively stored.

Thereby, it is possible to check whether the rewrite program as secret information not to be leaked to third parties is correctly downloaded in the semiconductor integrated circuit or not, while maintaining the confidentiality of the rewrite program. Further, when the rewrite program is not correctly stored in the second storage means, information of a position where the rewrite program is not correctly stored can be obtained.

According to claim 12 of the present invention, in the semiconductor integrated circuit device defined in claim 11, the second storage means stores the rewrite program data, and data that is uniquely obtained from the program data according to a predetermined rule, in the two areas into which the area in the second storage means where the rewrite program is not stored is successively divided.

Thereby, it is possible to easily detect errors in the rewrite program stored in the second storage means, even when a decoding circuit is provided in front of the second storage means, and the output of the second storage means becomes a fixed value due to defects in the decoding circuit and thereby data matching occurs when an exclusive OR is taken, which makes it difficult to check whether the rewrite program is correctly stored in the second storage means or not.

According to claim 13 of the present invention, in the semiconductor integrated circuit device defined in claim 12, the uniquely obtained data is inverted data of the program data.

Thereby, it is possible to easily detect errors in the rewrite program stored in the second storage means, even when a decoding circuit is provided in front of the second storage means, and the output of the second storage means becomes a fixed value due to defects in the decoding circuit and thereby data matching occurs when an exclusive OR is taken, which makes it difficult to check whether the rewrite program is correctly stored in the second storage means or not.

According to claim 14 of the present invention, the semiconductor integrated circuit device defined in any of claims 8 to 13 further includes a ROM (Read Only Memory) in which the check program is previously stored; wherein the arithmetic processing unit is operated by the ROM to check whether the rewrite program is correct or not.

Thereby, it is prevented that the check program becomes dysfunctional due to a transfer error or the like of the check program, and the check program for checking whether the rewrite program is correctly stored in the second storage means or not can be provided with stability.

According to claim 15 of the present invention, the semiconductor integrated circuit device defined in any of claims 1 to 14 further includes, in the semiconductor integrated circuit, a decryption means for decrypting the encrypted rewrite program; wherein, when the rewrite program stored in the first storage means has previously been encrypted, the decryption means decrypts the encrypted program, and stores the decrypted rewrite program in the second storage means.

Thereby, it is possible to check whether the rewrite program which is secret information not to be leaked to third parties and has previously been encrypted is correctly downloaded in the semiconductor integrated circuit or not, while maintaining the confidentiality of the rewrite program.

According to claim 16 of the present invention, there is provided a semiconductor integrated circuit device having a second storage means in a semiconductor integrated circuit, in which a program that makes an arithmetic processing unit in the semiconductor integrated circuit perform an operation of processing contents is rewritably stored, and performing rewriting using a first storage means in which a previously encrypted rewrite program for rewriting is stored, which rewrite program makes the arithmetic processing unit perform an operation of processing the contents; and the semiconductor integrated circuit device includes, in the semiconductor integrated circuit, a decryption means for decrypting the encrypted rewrite program read from the first storage means, and transferring the decrypted rewrite program to the second storage means; and an encryption means for again encrypting the rewrite program stored in the second storage means; wherein the rewrite program encrypted by the encryption means is compared with the encrypted rewrite program stored in the first storage means.

Thereby, it is possible to check whether the rewrite program which is secret information not to be leaked to third parties and has previously been encrypted is correctly downloaded in the semiconductor integrated circuit or not, while maintaining the confidentiality of the rewrite program.

According to claim 17 of the present invention, in the semiconductor integrated circuit device defined in any of claims 11 to 13 and 16, when data are not correctly stored in the second storage means, a defective portion is detected, and the rewrite program stored in the first storage means is corrected.

Thereby, the rewrite program is corrected so that the portion of the second storage means where data are not correctly stored is not used, and then the corrected program is written in the second storage means, whereby the memory can be effectively utilized.

According to claim 18 of the present invention, in the semiconductor integrated circuit device defined in any of claims 1 to 17, the rewrite program that is stored outside the semiconductor integrated circuit device is downloadable into the semiconductor integrated circuit.

Thereby, even when the rewrite program is stored outside the semiconductor integrated circuit device, the rewrite program can be downloaded using a communication means such as the Internet, whereby it is possible to check whether the rewrite program as secret information not to be leaked to third parties is correctly stored or not, while maintaining the confidentiality.

According to claim 19 of the present invention, there is provided a data storage verification device comprising: means for storing arbitrary data in an area which is accessible from the outside; means for outputting the arbitrary data to the outside, and judging whether the arbitrary data is correctly stored or not; and means for storing secret data in an area which is inaccessible from the outside, when it is judged that the arbitrary data is correctly stored.

Thereby, it is possible to check whether the secret data is correctly stored in the externally inaccessible area or not while maintaining the confidentiality of the secret data, by writing dummy data or the like into the externally accessible area, and reading the written dummy data to check the same.

According to claim 20 of the present invention, there is provided a data storage verification device comprising: means for storing secret data in an area which is inaccessible from the outside; and means for outputting a specific portion of the secret data to the outside.

Thereby, it is possible to check whether the secret data is correctly downloaded or not while maintaining the confidentiality of the secret data, by reading only a specific portion of the secret data stored in the externally inaccessible area, and verifying the specific portion.

According to claim 21 of the present invention, there is provided a data storage verification device comprising: means for storing secret data including a program in an area which is inaccessible from the outside; and means for executing the stored program, and outputting the result to the outside.

Thereby, it is possible to check whether the secret data is correctly downloaded or not while maintaining the confidentiality of the secret data, by executing the program included in the secret data stored in the externally inaccessible area, and outputting the execution result to the outside to verify the same.

According to claim 22 of the present invention, there is provided a data storage verification device comprising: first means for storing secret data including an inspection program and a secret program into an area which is inaccessible from the outside; second means for executing the inspection program, and outputting the result to the outside; and third means for executing the secret program after completion of the second means.

Thereby, it is possible to reliably check whether the secret data is correctly downloaded or not while maintaining the confidentiality of the secret data, by executing the program included in the secret data stored in the externally inaccessible area, and outputting the execution result to the outside to verify the same.

According to claim 23 of the present invention, there is provided a data storage verification device comprising: means for storing secret data in an area which is inaccessible from the outside; means for performing a predetermined arithmetic operation using the secret data, simultaneously with the storage; and means for outputting the result of the arithmetic operation to the outside.

Thereby, it is possible to check whether the secret data is correctly downloaded or not while maintaining the confidentiality of the secret data, by storing the secret data in the externally inaccessible area, and performing a predetermined operation using the secret data, and then outputting the operation result to the outside to verify the same.

According to claim 24 of the present invention, there is provided a data storage verification device comprising: fourth means for storing secret data in a first area which is inaccessible from the outside; fifth means for storing an inspection program which is a part of the secret data and is stored in the first area, into a second area; and sixth means for executing the inspection program stored in the second area to verify correctness of the secret data stored in the first area.

Thereby, it is possible to check whether the secret data is correctly downloaded or not while maintaining the confidentiality of the secret data, by storing the secret data in the externally inaccessible first area while storing the inspection program as a part of the secret data in the second area, and performing inspection using the inspection program, and then outputting the inspection result to the outside to verify correctness of the secret data stored in the first area.

According to claim 25 of the present invention, the data storage verification device defined in claim 24 further includes seventh means for transferring control to a command of the first area after completion of the sixth means.

Thereby, it is possible to transfer the control to execution of the command included in the original secret data, after checking whether the secret data is correctly downloaded or not while maintaining the confidentiality of the secret data.

According to claim 26 of the present invention, in the data storage verification device defined in claim 24, the fifth means executes storage of the inspection program according to a command that exists in the secret data stored in the first area.

Thereby, it is possible to carry out storage of the inspection program for checking whether the secret data is correctly downloaded or not while maintaining the confidentiality of the secret data, according to the command that exists in the secret data.

According to claim 27 of the present invention, in the data storage verification device as defined in claim 24, the fifth means executes the inspection program according to a command that has been stored in a third area before execution of storage by the fourth means.

Thereby, it is possible to carry out storage of the inspection program for checking whether the secret data is correctly downloaded or not while maintaining the confidentiality of the secret data, according to the command that has been stored before the storage of the secret data.

According to claim 28 of the present invention, there is provided a data storage verification device comprising: means for decrypting secret data; means for storing the decrypted data in an area which is inaccessible from the outside; means for encrypting the stored data; and means for comparing the encrypted data with the secret data to judge whether the stored data is correctly stored or not.

Thereby, it is possible to check whether the secret data is correctly downloaded or not while maintaining the confidentiality of the secret data, by encrypting the secret data which has once been decrypted and stored in the externally inaccessible area, and comparing the encrypted secret data with the original secret data that has previously been encrypted.

According to claim 29 of the present invention, there is provided a data storage verification device comprising: 21st means for storing secret program in an area which is inaccessible from the outside; 22nd means for reading the stored program; 23rd means for judging correctness of the read program for each command unit; 24th means for again storing a correct command in an empty area in the area that is inaccessible from the outside, when it is judged that the read program is incorrect; 25th means for storing a command for making a command next to the again-stored command jump to an address next to the address that is judged as incorrect; and 26th means for storing, in the area that is judged as incorrect, a command for making a jump to the address of the again-stored command.

Thereby, the secret program is stored in the externally inaccessible area, and correctness of the stored program is judged for each reading command unit. As for a command that is judged as incorrect control is jumped to a correct command that is stored in an empty area in the externally inaccessible area. Therefore, even when a command that is not correctly stored is included in part of the secret program when the secret program is stored, the incorrect command can be replaced with a correct command stored in an empty area to execute the correct command.

According to claim 30 of the present invention, there is provided a data storage verification method comprising: step of storing arbitrary data in an area which is accessible from the outside; step of outputting the arbitrary data to the outside, and judging whether the arbitrary data is correctly stored or not; and step of storing secret data in an area which is inaccessible from the outside, when it is judged that the arbitrary data is correctly stored.

Thereby, it is possible to check whether the secret data is correctly stored in the externally inaccessible area or not while maintaining the confidentiality of the secret data, by writing dummy data or the like into the externally accessible area, and reading the written dummy data to check the same.

According to claim 31 of the present invention, there is provided a data storage verification method comprising: step of storing secret data in an area which is inaccessible from the outside; and step of outputting a specific portion of the secret data to the outside.

Thereby, it is possible to check whether the secret data is correctly downloaded or not while maintaining the confidentiality of the secret data, by reading only a specific portion of the secret data stored in the externally inaccessible area, and verifying the specific portion.

According to claim 32 of the present invention, there is provided a data storage verification method comprising: step of storing secret data including a program in an area which is inaccessible from the outside; and step of executing the stored program, and outputting the result to the outside.

Thereby, it is possible to check whether the secret data is correctly downloaded or not while maintaining the confidentiality of the secret data, by executing the program included in the secret data stored in the externally inaccessible area, and outputting the execution result to the outside to verify the same.

According to claim 33 of the present invention, there is provided a data storage verification method comprising: first step of storing secret data including an inspection program and a secret program into an area which is inaccessible from the outside; second step of executing the inspection program, and outputting the result to the outside; and third step of executing the secret program after completion of the second step.

Thereby, it is possible to check whether the secret data is correctly downloaded or not while maintaining the confidentiality of the secret data, by executing the program included in the secret data stored in the externally inaccessible area, and outputting the execution result to the outside to verify the same.

According to claim 34 of the present invention, there is provided a data storage verification method comprising: step of storing secret data in an area which is inaccessible from the outside; step of performing a predetermined arithmetic operation using the secret data, simultaneously with the storage; and step of outputting the result of the arithmetic operation to the outside.

Thereby, it is possible to check whether the secret data is correctly downloaded or not while maintaining the confidentiality of the secret data, by storing the secret data in the externally inaccessible area, and performing a predetermined operation using the secret data, and then outputting the operation result to the outside to verify the same.

According to claim 35 of the present invention, there is provided a data storage verification method comprising: fourth step of storing secret data in a first area which is inaccessible from the outside; fifth step of storing an inspection program which is a part of the secret data and is stored in the first area, into a second area; and sixth step of executing the inspection program stored in the second area to verify correctness of the secret data stored in the first area.

Thereby, it is possible to check whether the secret data is correctly downloaded or not while maintaining the confidentiality of the secret data, by storing the secret data in the externally inaccessible first area while storing the inspection program as a part of the secret data in the second area, and performing inspection using the inspection program, and then outputting the inspection result to the outside to verify correctness of the secret data stored in the first area.

According to claim 36 of the present invention, the data storage verification method defined in claim 36 further includes seventh step of transferring control to a command of the first area after completion of the sixth step.

Thereby, it is possible to transfer the control to execution of the command included in the original secret data, after checking whether the secret data is correctly downloaded or not while maintaining the confidentiality of the secret data.

According to claim 37 of the present invention, in the data storage verification method defined in claim 35, the fifth step executes storage of the inspection program according to a command that exists in the secret data stored in the first area.

Thereby, it is possible to carry out storage of the inspection program for checking whether the secret data is correctly downloaded or not while maintaining the confidentiality of the secret data, according to the command that exists in the secret data.

According to claim 38 of the present invention, in the data storage verification method as defined in claim 35, the fifth step executes the inspection program according to a command that has been stored in a third area before execution of storage in the fourth step.

Thereby, it is possible to carry out storage of the inspection program for checking whether the secret data is correctly downloaded or not while maintaining the confidentiality of the secret data, according to the command that has been stored before the storage of the secret data.

According to claim 39 of the present invention, a data storage verification method comprising: step of decrypting secret data; step of storing the decrypted data in an area which is inaccessible from the outside; step of encrypting the stored data; and step of comparing the encrypted data with the secret data to judge whether the stored data is correctly stored or not.

Thereby, it is possible to check whether the secret data is correctly downloaded or not while maintaining the confidentiality of the secret data, by encrypting the secret data which has once been decrypted and stored in the externally inaccessible area, and comparing the encrypted secret data with the original secret data that has previously been encrypted.

According to claim 40 of the present invention, there is provided a data storage verification method comprising: step of storing secret program in an area which is inaccessible from the outside; step of reading the stored program; step of judging correctness of the read program for each command unit; step of again storing a correct command in an empty area in the area that is inaccessible from the outside, when it is judged that the read program is incorrect; step of storing a command for making a command next to the again-stored command jump to an address next to the address that is judged as incorrect; and step of storing, in the area that is judged as incorrect, a command for making a jump to the address of the again-stored command.

Thereby, the secret program is stored in the externally inaccessible area, and correctness of the stored program is judged for each reading command unit. As for a command that is judged as incorrect, control is jumped to a correct command that is stored in an empty area in the externally inaccessible area. Therefore, even when a command that is not correctly stored is included in part of the secret program when the secret program is stored, the incorrect command can be replaced with a correct command stored in an empty area to execute the correct command.

### BRIEF DESCRIPTION OF THE DRAWINGS

FIG. 1 is a diagram illustrating a semiconductor integrated circuit device according to a first embodiment of the present invention.

FIG. 2 is a flowchart for explaining the operation of the semiconductor integrated circuit device according to the first embodiment of the present invention.

FIG. 3 is a diagram illustrating a semiconductor integrated circuit device according to a second embodiment of the present invention.

FIG. 4 is a flowchart for explaining the operation of the semiconductor integrated circuit device according to the second embodiment of the present invention.

FIG. 5 is a diagram illustrating a semiconductor integrated circuit device according to a third embodiment of the present invention.

FIG. 6 is a diagram illustrating the semiconductor integrated circuit device according to the third embodiment of the present invention.

FIG. 7 is a diagram illustrating an example of an execution program for a semiconductor integrated circuit according to the third embodiment of the present invention.

FIG. 8 is a diagram illustrating a semiconductor integrated circuit device according to a fourth embodiment of the present invention.

FIG. 9 is a block diagram illustrating a semiconductor integrated circuit device according to a fifth embodiment of the present invention.

FIG. 10 is diagram illustrating an example of a structure of a RAM (second storage means) in the semiconductor integrated circuit device according to the fifth embodiment of the present invention.

FIG. 11 is a block diagram illustrating a semiconductor integrated circuit device according to a sixth embodiment of the present invention.

FIG. 12 is a diagram illustrating an example of a structure of a RAM (second storage means) 1106 in the semiconductor integrated circuit device according to the sixth embodiment of the present invention.

FIG. 13 is a schematic diagram illustrating data arrangement in a memory 1102 according to the sixth embodiment of the present invention.

FIG. 14 is a block diagram illustrating a semiconductor integrated circuit device according to a seventh embodiment of the present invention.

FIG. 15 is a block diagram illustrating a semiconductor integrated circuit device according to an eighth embodiment of the present invention.

FIG. 16 is a flowchart for explaining the operation of the semiconductor integrated circuit device according to the eighth embodiment of the present invention.

FIG. 17 is a diagram for explaining an example of correcting a program of the semiconductor integrated circuit device according to the eighth embodiment of the present invention.

### BEST MODE TO EXECUTE THE INVENTION

Hereinafter, embodiments of the present invention will be described with reference to the drawings.

### Embodiment 1

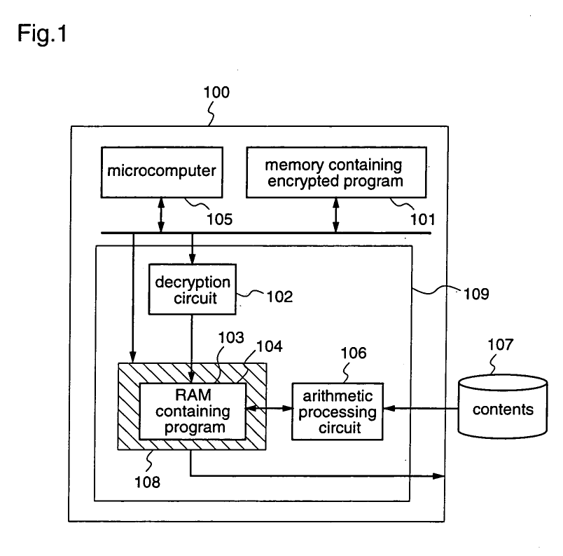

FIG. 1 is a diagram illustrating a semiconductor integrated circuit device according to a first embodiment of the present invention, for explaining an example of downloading an encrypted rewrite program.

In FIG. 1, reference numeral 100 denotes a semiconductor integrated circuit device into which an encrypted rewrite program is downloaded, and it includes, for example, a microcomputer 105 for control, and a memory (first storage means) 101 in which a previously encrypted rewrite program is stored. A semiconductor integrated circuit 109 comprises a decryption circuit (decryption means) 102 for decrypting the encrypted rewrite program, a rewritable RAM (second storage means) 108, and an arithmetic processing circuit (arithmetic processing unit) 106 which operates according to a control procedure of a decrypted program, and processes contents data 107. The rewrite program is altered to make the arithmetic processing circuit 106 have different functions.

Further, in the semiconductor integrated circuit device according to the first embodiment of the present invention, the rewritable RAM 108 comprises an externally readable area 103 which can be read from the outside of the semiconductor integrated circuit 109, and an externally unreadable area 104 which cannot be read from the outside of the semiconductor integrated circuit 109. The externally unreadable area 104 is realized by providing, for example, a switch that connects an address bus from the outside to the externally unreadable area 104 as well as the external readable area 103 but does not connect a data bus to the externally unreadable area 104 when reading data to the outside.

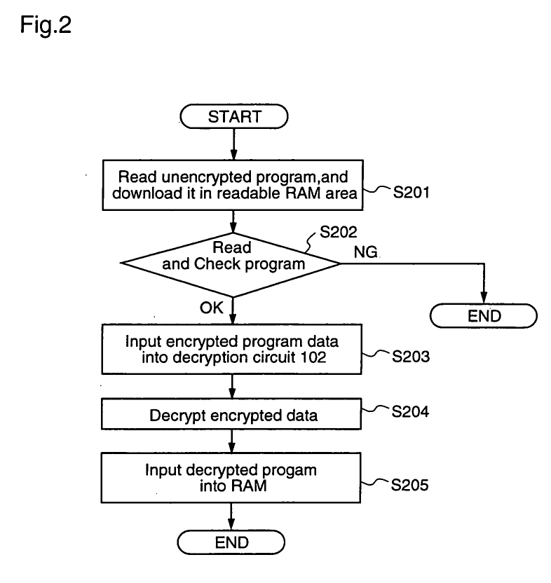

The operation of the semiconductor integrated circuit device 100 constructed as described above will be described using a flowchart shown in FIG. 2.

Unencrypted data is input to the externally readable area 103 of the rewritable RAM 108 under control of the microcomputer 105 (step S201). Next, the data inputted to the externally readable area 103 is read out of the semiconductor integrated circuit 109 to check whether the data is correct or not by the control microcomputer 105 or the like (step S202). When the result of the check in step S202 is “correct”, the encrypted write program stored in the memory 101 is input to the decryption circuit 102 under control of the microcomputer 105 (step S203), and the decryption circuit 102 decrypts the encrypted write program (step S204). Next, the rewrite program decrypted in step S204 is input to the externally unreadable area 104 of the rewritable RAM 108 (step S205). Through the above-mentioned processes, it is possible to check whether the rewrite program is correctly stored or not, while maintaining the confidentiality of the rewrite program that should not be leaked to third parties.

It is considered that, when the unencrypted data written from the outside can be correctly read out as described above, no failure occurs in the circuit executing the writing and reading, leading to a conclusion that, also when the rewrite program is stored in the externally unreadable area 104, this storage can be carried out without any trouble.

The data to be stored in the externally readable area 103 of the rewritable RAM 109 may be prepared inside or outside the semiconductor integrated circuit device so long as it is data for check.

In the semiconductor integrated circuit device according to the first embodiment as described above, when a rewrite program as secret information not to be leaked to third parties is input to the rewritable RAM 108, data for checking is stored in the externally readable area 103, between the externally readable area 103 and the externally unreadable area 104 which are included in the RAM 108. When the result of the data check is “correct”, the program of the secret information is stored in the externally unreadable area 104, thereby enabling checking of defects in manufacturing the RAM 108 that contains the rewrite program as secret information not to be leaked to third parties, as well as the path until the rewrite program is inputted.

### Embodiment 2

A semiconductor integrated circuit according to a second embodiment of the present invention is provided with a control circuit for reading only a specific portion of a stored rewritable program, for checking whether the rewrite program is correctly stored in a rewritable RAM in the semiconductor integrated circuit, while maintaining the confidentiality of the rewrite program as secret information not to be leaked to third parties.

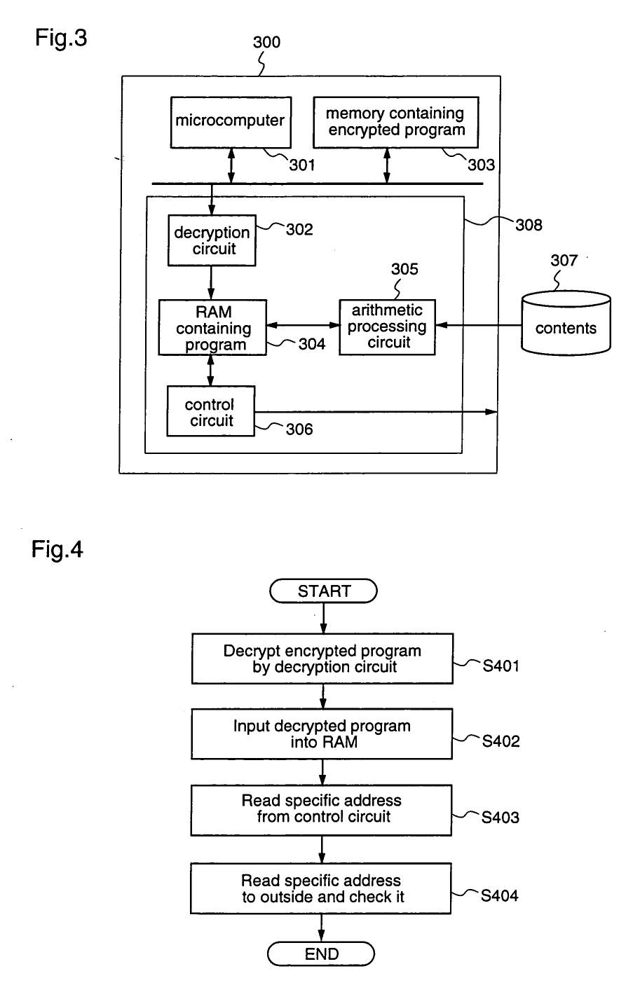

FIG. 3 is a diagram illustrating a semiconductor integrated circuit device according to the second embodiment of the present invention, for explaining an example of downloading an encrypted rewrite program.

In FIG. 3, reference numeral 300 denotes a semiconductor integrated circuit device into which an encrypted rewrite program is downloaded, 301 denotes a microcomputer for control, and 303 denotes a memory (first storage means) in which a previously encrypted rewrite program is stored. A semiconductor integrated circuit 308 comprises a decryption circuit (decryption means) 302 for decrypting the encrypted rewrite program, a rewritable RAM (second storage means) 304 for holding the rewrite program decrypted by the decryption circuit 302, an arithmetic processing circuit (arithmetic processing unit) 305 which operates according to the control procedure of the decrypted program, and processes contents data 307, and a control circuit 306 for performing control so as to output only a specific address of the rewrite program stored in the RAM 304. The control circuit 306 has a function of reading only a specific address of the RAM 304 to the outside.

Next, the operation of the semiconductor integrated circuit device 300 constructed as described above will be described using a flowchart shown in FIG. 4.

The encrypted rewrite program outputted from the memory 303 containing the rewrite program is decrypted by the decryption circuit 302 (step S401), and the decrypted rewrite program is input to the RAM 304 (step S402). Next, reading of a specific address of the rewrite program stored in the RAM 304 is carried out by the control circuit 306 (step S403), and the program of the specific address is read out of the semiconductor integrated circuit 308 and checked (step S404).

The above-mentioned semiconductor integrated circuit device according to the second embodiment of the present invention is provided with the control circuit for performing control so as to read out only a specific address to the outside of the semiconductor integrated circuit after the rewrite program is stored in the RAM 304, and the read specific address is checked, whereby it is possible to judge whether the rewrite program as secret information not to be leaked to third parties is correctly stored in the RAM 304, while maintaining the confidentiality of the rewrite program.

This is because, even when only a specific address is read to the outside, if this address is a correct value, it can be thought that the whole rewrite program is correctly stored.

While in this second embodiment the control circuit reads out only a specific address, it may read out only specific bits to the outside of the semiconductor integrated circuit to check the read specific bits. Also in this case, it is possible to judge whether the rewrite program is stored in the RAM or not.

### Embodiment 3

A semiconductor integrated circuit device according to a third embodiment of the present invention executes a part of a rewrite program stored in a rewritable RAM in the semiconductor integrated circuit, in order to check whether the rewrite program as secret information not to be leaked to third parties is correctly stored in the RAM in the semiconductor integrated circuit.

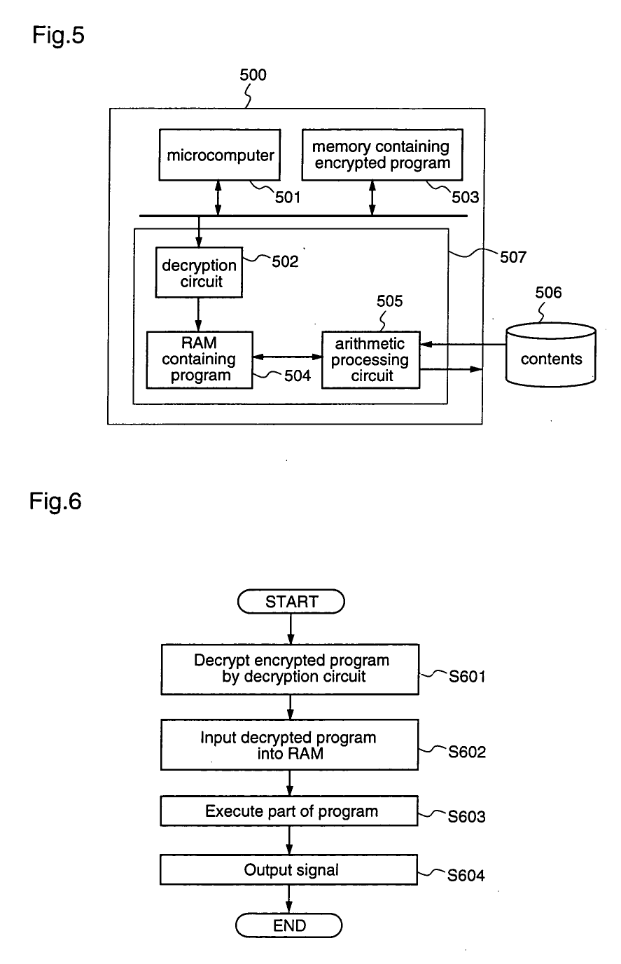

FIG. 5 is a diagram illustrating a semiconductor integrated circuit device according to a third embodiment of the present invention, for explaining an example of downloading an encrypted rewrite program.

In the figure, reference numeral 500 denotes a semiconductor integrated circuit device into which an encrypted rewrite program is downloaded, 501 denotes a microcomputer for control, and 503 denotes a memory (first storage means) in which a previously encrypted rewrite program is stored. A semiconductor integrated circuit 507 comprises a decryption circuit (decryption means) 502 for decrypting the encrypted rewrite program, a rewritable RAM (second storage means) 504 for holding the rewrite program decrypted by the decryption circuit 502, and an arithmetic processing circuit (arithmetic processing unit) 505 which operates according to the control procedure of the decrypted program, and processes contents data 506.

The previously encrypted rewrite program includes a program (check program) for executing a part of the rewrite program after download. The check program may be inserted into the rewrite program during decryption.

Next, the operation of the semiconductor integrated circuit 500 constituted as described above will be described using a flowchart shown in FIG. 6.

The encrypted rewrite program outputted from the memory 503 is decrypted by the decryption circuit 502 (step S601), and the decrypted rewrite program is input to the RAM 504 (step S602). Next, a part of the rewrite program stored in the RAM 504 is executed (step S603), and it is checked whether the part of the rewrite program is correct or not, and then a signal informing whether the part of the rewrite program is correct or not is output to the outside of the semiconductor integrated circuit 507 (step S604).

At this time, if the contents of the program to be executed is such as memory check and a result of the check is obtained by executing the memory check, the judgement as to whether the program is correctly stored in the RAM 504 or not can be carried out with higher reliability.

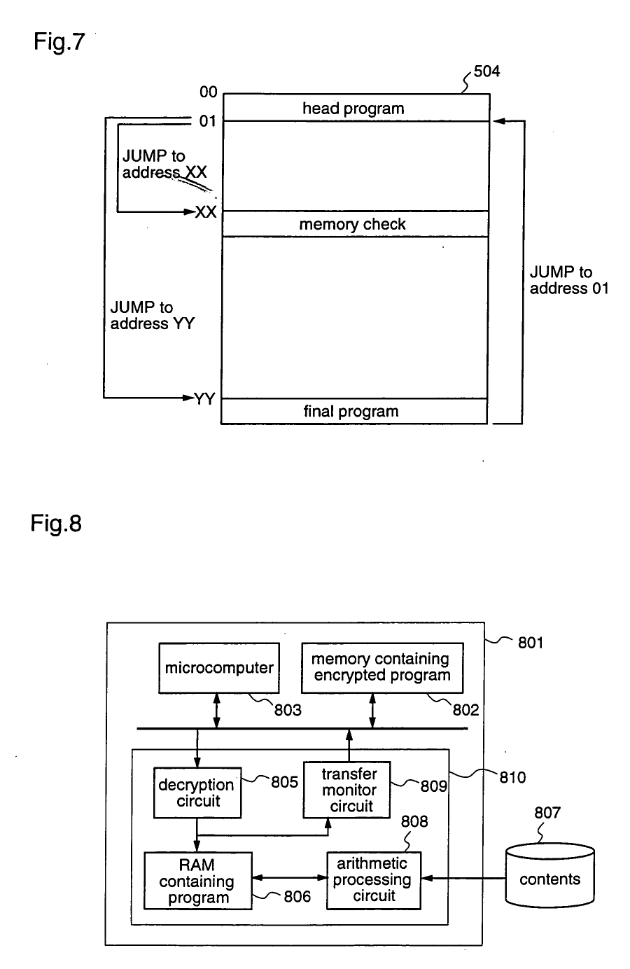

Further, it is assumed that, as shown in FIG. 7, the contents of the program to be executed is a program for executing a JUMP command to perform programs in discontinuous areas and, for example, a command of JUMP to address XX of a program of memory check is executed at a head program. Then, JUMP is made from the head program to the address XX of the memory check program to carry out memory check, whereby the judgement as to whether the program is correctly stored in the RAM 504 or not can be carried out with higher reliability. Further, it is assumed that a command of JUMP to address YY of a final program is executed at the head program. Then, JUMP is made from the head program to the address YY of the final program, which final program is a program to return to address 01 after execution of the final program, and thereafter, it is checked whether the program is correctly executed or not, whereby it can be judged whether the rewrite program has been written up to the end of the RAM. Particularly, in the encryption method in which even a single mistake of decryption adversely affects the subsequent data, it is possible to judge with higher reliability whether the rewrite program is correctly stored or not.

In the semiconductor integrated circuit device according to the third embodiment of the present invention, after the rewrite program is stored in the RAM 504, a part of the rewrite program is executed, and a signal is output when the program is correctly executed, whereby it is possible to judge whether the rewrite program is correctly stored in the RAM or not.

Further, since the discontinuous program areas are successively executed in the RAM 504 containing the rewrite program, it is possible to check whether the rewrite program is correctly stored up to the end of the RAM or not, whereby the correct/error check for the rewrite program stored in the RAM can be carried out with higher reliability.

### Embodiment 4

A semiconductor integrated circuit device according to a fourth embodiment of the present invention is provided with a transfer monitor circuit for monitoring transferred data when a rewrite program is written into a RAM in a semiconductor integrated circuit, and an arithmetic sum is obtained for every data unit to be transferred and the results are held to take a checksum or the like, in order to check whether the rewrite program as secret information not to be leaked to third parties is correctly stored in the semiconductor integrated circuit or not.

FIG. 8 is a diagram illustrating the semiconductor integrated circuit device according to the fourth embodiment of the present invention, for explaining an example of storing an encrypted rewrite program into a semiconductor integrated circuit.

In FIG. 8, reference numeral 801 denotes a semiconductor integrated circuit device into which an encrypted rewrite program is downloaded, numeral 802 denotes a memory (first storage means) in which the previously encrypted rewrite program is stored, and numeral 803 denotes a microcomputer for control. A semiconductor integrated circuit 810 comprises a decryption circuit (decryption means) 805 for decrypting the encrypted rewrite program, a RAM (second storage means) 806 for holding the rewrite program decrypted by the decryption circuit 805, an arithmetic processing circuit (arithmetic processing unit) 808 which operates according to the control procedure of the decrypted program, and processes contents data 807, and a transfer monitor circuit (transfer monitor means) 809 for obtaining an arithmetic sum for each data unit transferred from the decryption circuit 805.

Next, the operation of the semiconductor integrated circuit device according to the fourth embodiment will be described.

In the semiconductor integrated circuit device 801 constructed as described above, the rewrite program which has previously been encrypted and stored in the memory 802 is stored in the RAM 806 while decrypting the program with the decryption circuit 805 under control of the control microcomputer 803. Simultaneously, the transfer monitor circuit 809 continuously monitors the signal line from the decryption circuit 805 to the RAM 806, which is a part of a data pass for data transfer, and an arithmetic sum for each data unit transferred is obtained to hold the result. When transfer of a predetermined amount of data among the data stored in the memory 802 has been completed, the arithmetic sum data held by the transfer monitor circuit 809 is read out, and the read data is compared with an arithmetic sum of data to be obtained when transfer is correctly carried out, which has previously been calculated. When these arithmetic sums are equal to each other, it is judged that transfer is correctly carried out, and thereafter, processing to be originally executed is carried out. If these arithmetic sums are different values, it is judged that transfer is not correctly carried out, and proper processing is carried out, for example, the data stored in the memory 802 is transferred again.

The semiconductor integrated circuit device according to the fourth embodiment of the present invention is provided with the transfer monitor circuit for monitoring the transfer data of the rewrite program for rewriting, and calculating an arithmetic sum for each data unit transferred, and compares the arithmetic sum obtained by the transfer monitor circuit with an arithmetic sum of data to be obtained when transfer is correctly carried out, which has previously been calculated. Therefore, it is possible to judge whether download is correctly carried out or not, without reading out the rewrite program that is secret information not to be leaked to third parties.

While in this fourth embodiment a checksum is obtained using the data transfer monitor circuit, a CRC check circuit or an ECC check circuit may be used instead of the checksum so long as it can judge whether each unit (cluster) of data has a bit error or not, with the same effects as mentioned above. That is, the present invention is not particularly restricted to the monitor system.

### Embodiment 5

In a semiconductor integrated circuit device according to a fifth embodiment of the present invention, an arithmetic processing circuit is operated from a work memory thereof, and program data stored in a RAM is input to the arithmetic processing circuit, and a checksum or the like is obtained in the arithmetic processing circuit, in order to check whether a rewrite program as secret information not to be leaked to third parties is correctly stored in a semiconductor integrated circuit or not.

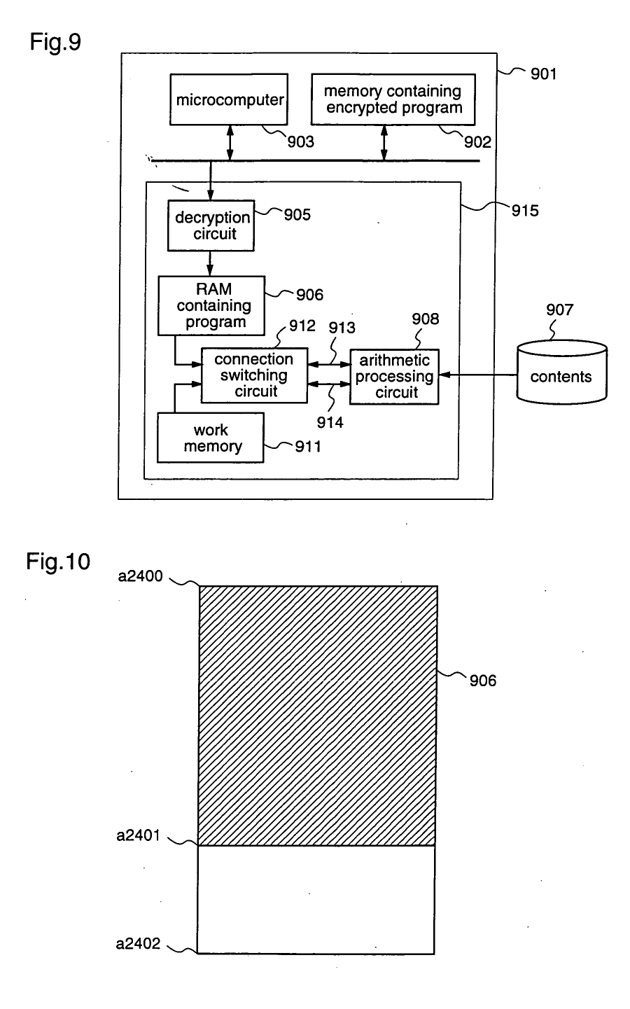

FIG. 9 is a diagram illustrating the semiconductor integrated circuit device according to the fifth embodiment of the present invention, for explaining an example of storing an encrypted rewrite program in a semiconductor integrated circuit.

In FIG. 9, reference numeral 901 denotes a semiconductor integrated circuit device having an encrypted rewrite program, 902 denotes a memory (first storage means) in which a-previously encrypted rewrite program is stored, and 903 denotes a microcomputer for control. A semiconductor integrated circuit 915 comprises a decryption circuit (decryption means) 905 for decrypting the encrypted rewrite program, a RAM (second storage means) 906 for holding the rewrite program decrypted by the decryption circuit 905, an arithmetic processing circuit (arithmetic processing unit) 908 which operates according to the control procedure of the decrypted program, and processes contents data 907, a work memory 911 of the arithmetic processing circuit 908, and a connection switching circuit (connection switching means) 912 for selectively connecting the RAM 906 and the work memory 911 to a bus 913 for reading a command program of the arithmetic processing circuit 908 and to a bus 914 for inputting/outputting data, respectively. In this fifth embodiment, a mode in which the RAM 906 is connected to the bus 913 for reading the command program of the arithmetic processing circuit 908 while the work memory 911 is connected to the bus 914 for inputting/outputting data is denoted as a first mode, and a mode in which the RAM 906 is connected to the bus 914 for inputting/outputting data while the work memory 911 is connected to the bus 913 for reading the command program of the arithmetic processing circuit 908 is denoted as a second mode, and the connecting switching circuit 912 selects one of the first mode and the second mode. In the normal state, the first mode is selected, and the arithmetic processing circuit 908 can take so-called Harvard architecture independently of the bus 913 that reads the command program of its own and the bus 914 that reads the data, whereby data processing of the contents data 907 can be performed more speedily.

Next, the operation of the semiconductor integrated circuit device 901 according to the fifth embodiment of the present invention will be described.

The rewrite program which has previously been encrypted and stored in the memory 902 is decrypted by the decryption circuit 905 and stored in the RAM 906 under control of the control microcomputer 903. Thereafter, the operation of the arithmetic processing circuit 908 is started. At this time, the arithmetic processing circuit 908 is operated according to an execution step that is incorporated in the rewrite program stored in the RAM 906.

Further, a program (check program) for checking whether the rewrite program is correctly stored in the RAM 906 or not is previously incorporated in the rewrite program stored in the RAM 906. In this fifth embodiment, two programs are incorporated as machine word programs, i.e., a program for reading the data from the RAM 906 on the data inputting/outputting bus 914, and obtaining a checksum and comparing the checksum with a predetermined value to check whether the data stored in the RAM 906 is correct or not, and a program for returning the mode of the connection switching circuit 912 back to the first mode after it is judged that the data stored in the RAM 906 is correct. Furthermore, a program for developing the incorporated machine word data directly into the work memory 911, and a program for changing the mode of the connection switching circuit 912 to the second mode, are previously incorporated in the rewrite program.

After the operation is started, initially, the above-mentioned two programs for checking whether the program stored in the RAM 906 is correct or not, which are the machine word data, are developed in the work memory 911, by the program for developing the previously incorporated machine word data directly into the work memory 911. Thereafter, the connection switching circuit 912 is changed to the second mode by the program for changing the connection switching circuit 912 to the second mode. Thereby, the work memory 911 is connected to the bus 913 for reading the command program of the arithmetic processing circuit 908, and the arithmetic processing circuit 908 executes, between the two programs which have been developed in the work memory 911, the program for reading the data from the RAM 906 on the data inputting/outputting bus 914, and obtaining a checksum and comparing the checksum with a predetermined value to check whether the data stored in the RAM 906 is correct or not. When it is judged that the rewrite program stored in the RAM 906 is correct, the remaining one of the two programs developed in the work memory 911, i.e., the program of returning the connection switching circuit 912 back to the first mode, is executed, whereby the connection switching circuit 912 is changed to the first mode, and thereafter, the program to be originally executed is carried out.

Next, an example of the RAM 906 constituted as shown in FIG. 10 will be described.

The RAM 906 has a logical structure as shown in FIG. 10. In FIG. 10, a2400, a2401, and a2402 indicate memory addresses, and the rewrite program is stored in a space that is hatched with right-up diagonal lines, and starts from the address a2400 and ends at address a2401. Further, for example, a parity flag corresponding to each predetermined unit such as a memory address, of the data stored in the right-up diagonally hatched space and starts from the address a2400 and ends at address a2401, is stored in a space that starts from the address a2401 and ends at the address a2402.

Further, as for check programs to be previously incorporated in the rewrite program stored in the RAM 906, there are three programs to be incorporated as machine word data: a program for performing so-called parity operation which includes reading the data from the RAM 906 on the data inputting/outputting bus 914, and counting “1” bits in the read data to check whether the number of “1” bits is odd or even; a program for judging whether the rewrite program stored in the memory 2406 is correct or not by reading information of the parity flag stored in the space from the address a2401 to the address a2402 corresponding to the read data and then comparing the parity flag information with the result of the parity operation; and a program for changing the connection switching circuit 912 back to the first mode after it is judged that the data is correct. Furthermore, a program for directly developing the incorporated machine word data into the work memory, and a program for changing the connection switching circuit 912 to the second mode after the development of the machine word data into the work memory, are also previously been incorporated.

After the operation is started, initially, the above-mentioned three programs as the machine word data are developed in the work memory 911 by the program for developing the previously incorporated machine word data directly in the work memory 911. Thereafter, the connection switching circuit 912 is changed to the second mode by the program for changing the connection switching circuit 912 to the second mode. Thereby, the work memory 911 is connected to the bus 913 for reading the command program of the arithmetic processing circuit 908, and the arithmetic processing circuit 908 executes, among the three programs that have just been developed in the work memory 911, the program for performing the parity operation which includes reading the data from the memory on the data inputting/outputting bus 914, and counting “1” bits in the read data to check whether the number of “1” bits is odd or even, and thereafter, executes the program for judging whether the rewrite program stored in the RAM 906 is correct or not by reading information of the parity flag stored in the space from the address a2401 to the address a2402 corresponding to the read data and then comparing the parity flag information with the result of the parity operation. When the rewrite program is judged to be correct, the connection switching circuit 912 is changed to the first mode by the program for changing the connection switching circuit 912 back to the first mode, which program is the remaining one of the three programs developed in the work memory 911, and thereafter, the program to be originally executed is carried out.

Since the RAM 906 is constructed as described above, it is possible to check whether the rewrite program stored in the RAM 906 is correctly stored or not. When the rewrite program is not correctly stored, information about the place where the rewrite program is not correctly stored can be obtained.

The data to be stored in the space from the address a2401 to the address a2402 in the RAM 906 is not restricted to the parity flag. Any data may be stored so long as whether a cluster of data is correct or not can be judged. For example, CRC check and ECC check which have currently been well known may be employed with the same effects as mentioned above.

In the semiconductor integrated circuit device according to the fifth embodiment of the present invention, the check program for checking whether the rewrite program stored in the RAM 906 is correctly stored or not is developed in the work memory 911 of the arithmetic processing circuit, and the mode of the connection switching circuit 912 is changed to enable the command from the work memory 911, and then checksum or the like is obtained in the arithmetic processing circuit that receives the command from the work memory 911, whereby it is possible to check whether the rewrite program as secret information not to be leaked to third parties is correctly stored in the RAM 906 or not, while maintaining the confidentiality.

In the semiconductor integrated circuit device according to the fifth embodiment of the present invention, a checksum is obtained in the arithmetic processing circuit. However, any means, such as a CRC check circuit or an ECC check circuit, may be employed in place of the checksum so long as it can check whether a bit error occurs or not in each unit (cluster) of data.

### Embodiment 6

In a semiconductor integrated circuit device according to a sixth embodiment of the present invention, a check program for checking whether a rewrite program stored in a RAM is correct or not is previously stored in a ROM, and the rewrite program check operation is carried out according to the check program stored in the ROM, in order to reliably check whether the rewrite program as secret information not to be leaked to third parties is correctly stored in a semiconductor integrated circuit or not.

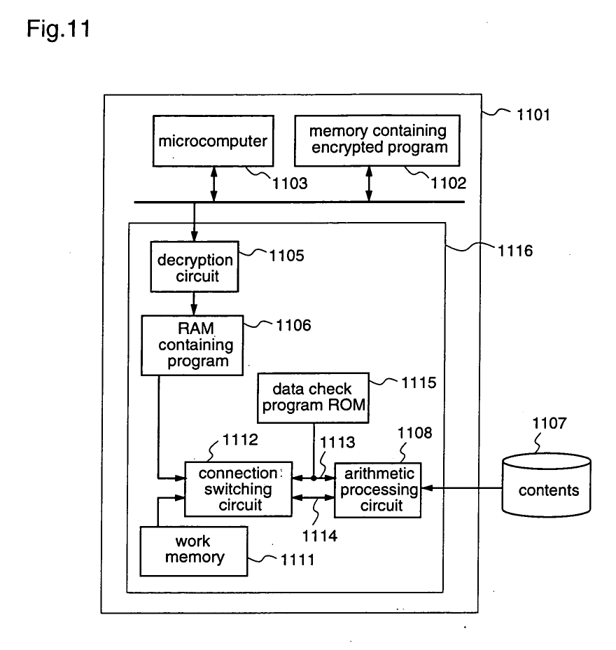

FIG. 11 is a diagram illustrating a semiconductor integrated circuit device according to a sixth embodiment of the present invention, for explaining an example of downloading an encrypted rewrite program into a semiconductor integrated circuit.

In FIG. 11, reference numeral 1101 denotes a semiconductor integrated circuit device having an encrypted rewrite program, and 1102 denotes a memory (first storage means) in which a previously encrypted rewrite program is stored. A semiconductor integrated circuit 1116 comprises a microcomputer 1103 for control, a decryption circuit (decryption means) 1105 for deciding the encrypted rewrite program, a RAM (second storage means) 1106 for holding the rewrite program decrypted by the decryption circuit 1105, an arithmetic processing circuit (arithmetic processing unit) 1108 which is operated according to the control procedure of the decrypted program, and processes contents data 1107, a work memory 1111 of the arithmetic processing circuit 1108, a connection switching circuit (connection switching means) 1112 for connecting the RAM 1106 and the work memory 1111 to a bus 1113 for reading a command program of the arithmetic processing circuit 1108 and to a bus 1114 for inputting/outputting data, respectively, and a ROM 1115 for holding a program (check program) for checking whether the rewrite program developed in the RAM 1106 is correct or not, which program is executable by the arithmetic processing circuit 1108. The ROM 1115 is always connected to the bus 1113 for reading a command program of the arithmetic processing circuit 1108. Since the first and second modes to be selected by the connection switching circuit 1112 are identical to those described for the fifth embodiment, repeated description is not necessary. Further, as in the fifth embodiment, the first mode is selected in the normal state.

Next, the operation of the semiconductor integrated circuit device according to the sixth embodiment of the present invention will be described.

First of all, the rewrite program which has previously been encrypted and stored in the memory 1102 is decrypted by the decryption circuit 1105 and stored in the RAM 1106 under control of the control microcomputer 1103. Thereafter, the operation of the arithmetic processing circuit 1108 is started. At this time, the switching circuit 1112 is in the first mode. The arithmetic processing circuit 1108 is operated according to an execution step of the rewrite program that is developed in the RAM 1106. The rewrite program includes a program for transferring the control to a program for data check which is stored in the ROM 1115, and this program is executed. After the execution program of the arithmetic processing circuit 1108 is transferred to the ROM 1115, the connection switching circuit 1112 is changed to the second mode.

Thereby, the RAM 1106 is connected to the data inputting/outputting bas 1114, and the arithmetic processing circuit 1108 reads the data stored in the RAM 1106 and judges whether the rewrite program is correct or not, according to the program for judging whether the rewrite program developed in the RAM 1106 is correct or not, which program is stored in the ROM 1115.

When it is judged that the rewrite program is correct, the connection switching circuit 112 is changed to the first mode by the program for changing the connection switching circuit 1112 back to the first mode, which program is incorporated in the ROM 1115, and thereafter, the program to be originally executed is carried out.

The method for checking whether the rewrite program stored in the RAM 1106 is correct or not is incorporated in the ROM 1115, and a checksum or the like is employed in this method. However, the present invention does not restrict the method, and any method may be employed so long as it can judge whether the rewrite program is correct or not for a predetermined unit (cluster) of data.

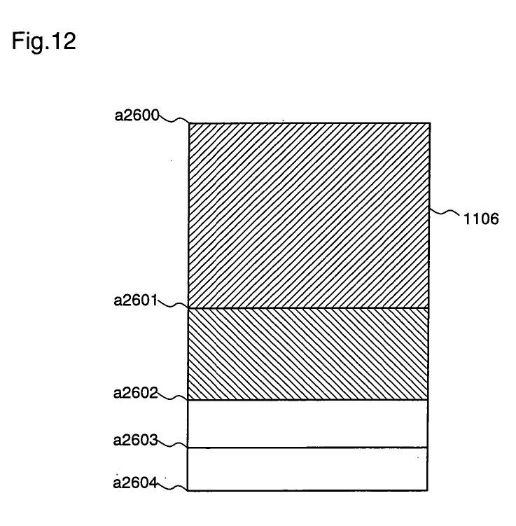

Next, a description will be given of a case where the RAM 1106 is constituted as shown in FIG. 12.

FIG. 12 is a diagram illustrating an example of the RAM 1106 of the semiconductor integrated circuit device according to the sixth embodiment of the present invention.

In FIG. 12, a2600, a2601, a2602, a2603, and a2604 denote memory addresses, and a2600 is a start address in the RAM 1106, and a2604 is an end address. As shown by a space hatched with right-up diagonal lines, a2601 indicates an address in a position just half the whole capacity of the RAM 1106. Further, as shown by a space hatched with right-down diagonal lines, a2602 indicates an address in a position just half the capacity of a space from the address a2601 to the end address a2604. Likewise, a2603 indicates an address in a position just half the capacity of a space from the address a2602 to the end address a2604.

A description will be given of the operation of the semiconductor integrated circuit device 1101 using the above-mentioned RAM 1106.

Initially, data is downloaded from the memory 1102 through the decryption circuit 1105 into the area from the address a2600 to the address a2601 in the RAM 1106. Thereafter, the same data as the data from the address a2600 to the address a2601, which have previously been developed and stored in the RAM 1102, are also downloaded while being decrypted, into the area from the address a2601 to the address a2604. Thereafter, the mode of the connection switching circuit 1112 is changed to read the data stored in the RAM 1106. During the reading, addresses that are located equidistant from the address a2600 and the address a2601 are successively accessed, and the obtained data are exclusive-ORed bit by bit. If the encrypted data are correctly decrypted, and no abnormal event occurs in the data path, and further, no abnormal event occurs in the bits in the storage area of the RAM 1106, the result becomes an exclusive OR of certain data and the same data, and therefore, it becomes 0. Accordingly, this procedure is successively repeated to check that each exclusive OR is 0, whereby it can be judged that the data from the memory 1102 are correctly developed through the decryption circuit 1105 into the RAM 1106. By repeatedly executing the above-mentioned procedure for every ½ of the remaining area, the program of the arithmetic processing circuit 1108 is decrypted and downloaded into the RAM 1106, and simultaneously, it is confirmed that the contents of the data are as expected.

Since the RAM 1106 is constructed as described above, when the exclusive OR in the above-mentioned procedure does not become 0 due to some defect, it can be judged that there is a defect in the data stored in the RAM 1106, and an address at which the defect occurs can be detected.

The amount of data to be developed from the memory 1102 into the RAM 1106 may be equal to or smaller than ½ of the area in the RAM 1106 where the rewrite program is not stored. However, in the above-mentioned method of taking an exclusive OR, since ½ is the maximum amount of readable data, it should be ½ to secure maximum writing efficiency.

While in this sixth embodiment data check is carried out on the basis of the program stored in the data check program ROM 1115 by using the RAM 1106 constructed as mentioned above, even when there is no data check program ROM 1115, a data check program may be previously incorporated in the program to be downloaded as in the fifth embodiment, whereby the same effect as mentioned above can be achieved.

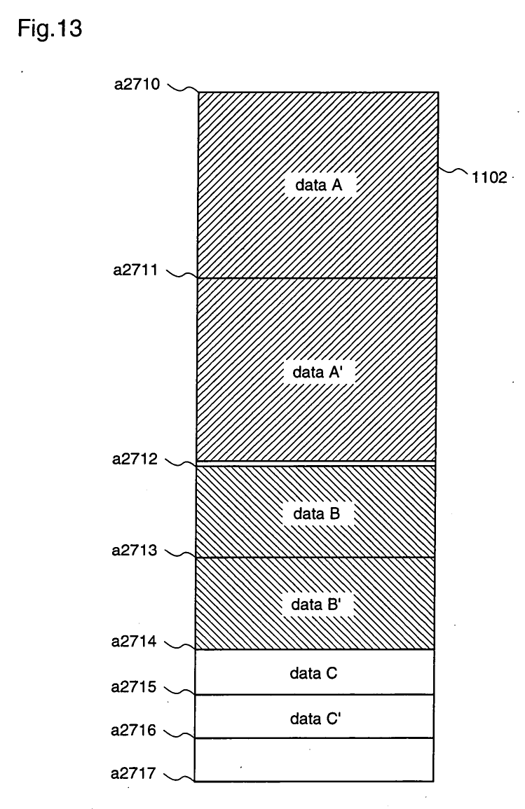

Next, a description will be given of a case where the memory 1102 is constructed as shown in FIG. 13.

FIG. 13 shows an example of the memory 1102 in the semiconductor integrated circuit device according to the sixth embodiment of the present invention.

In FIG. 13, a2710, a2711, a2712, a2713, a2714, a2715, a2716, and a2717 indicate addresses in the memory 1102. The address a2710 is a start address of the memory 1102, and the address a2717 is an end address of the memory 1102. Further, the data to be stored from the address a2600 to the address a2601 in the RAM 1106 shown in FIG. 12 are encrypted and stored in a space between the address a2710 and the address a2711. These data are called “data A” for convenience sake. Further, data which are obtained by inverting, for each bit, the data to be stored in the space from the address a2600 to the address a2601 of the RAM 1106, i.e., the “data A”, when decrypted by the decryption circuit 1105, are stored in a space between the address a2711 to the address a2712. These data are called “data A1” for convenience sake. Likewise, data which are obtained by encrypting the data to be stored in the space from the address a2601 to the address a2602 are stored in a space between the address a2712 and the address a2713, and Further, data which are obtained by inverting, for each bit, the data to be stored in the space from the address a2601 to the address a2602 of the RAM 1106 when decrypted by the decryption circuit 1105, are stored in a space between the address a2713 to the address a2714. These data are called “data B” and “data B1” for convenience sake. The same can be said for “data C” and “data C1”. The above-mentioned procedure is repeated, whereby all the programs and their inverted data to be stored in the RAM 1106 are encrypted and stored in the memory 1102.

The operation of the semiconductor integrated circuit device 1102 using the memory 1102 and the RAM 1106 constituted as described above will be described.

Initially, the “data A” are downloaded from the memory 1102 through the decryption circuit 1105 into the area from the address a2600 to the address a2601 in the RAM 1106. Thereafter, the “data A′”, which are obtained by encrypting the inverted data of the just-downloaded data and are stored in the memory 1102 as described above, are also downloaded while being decrypted. Thereafter, the mode of the connection switching circuit 1112 is changed to read the data stored in the RAM 1106. During the reading, addresses that are located equidistant from the address a2600 and the address a2601 are successively accessed, and the obtained data are ANDed for each bit. If the encrypted data are correctly decrypted, and no abnormal event occurs in the data path, and further, no abnormal event occurs in the bits in the storage area of the RAM 1106, the result becomes an AND of certain data and inverted data thereof, and therefore, it becomes 0. Accordingly, this procedure is successively repeated to check that each AND is 0, whereby it can be judged that the data from the memory 1102 are correctly developed through the decryption circuit 1105 into the RAM 1106. The data-equivalent to ½ of the remaining area in each procedure and the inverted data thereof are encrypted to be pairs of data such as “data B” and “data B′”, “data C” and “data C′” and stored by a necessary amount in the memory 1102. By repeatedly executing the above-mentioned procedure for every ½ of the remaining area, the program of the arithmetic processing circuit 1108 is decrypted and downloaded into the RAM 1106, and simultaneously, it is confirmed that the contents of the data are as expected.

Therefore, when the AND in the above-mentioned procedure does not become 0 due to some defect, it is judged that there is a defect in the data stored in the RAM 1106, and further, an address where the defect occurs can be detected. Further, when the decryption circuit 1105 has a defect for some reason and thereby the output to the RAM 1106 is a fixed value, an AND obtained from the data stored in the RAM 2506 in the above-mentioned procedure is an AND of certain data and the same data, and therefore, it is not 0. Thereby, it can be judged that the data are not correctly stored.

The amount of data to be developed from the memory 1102 into the RAM 1106 may be equal to or smaller than ½ of the area in the RAM 1106 where the rewrite program is not stored. However, in the above-mentioned method of taking an AND, since ½ of the remaining area is the maximum amount of readable data, it should be ½ to secure maximum writing efficiency.

While in this sixth embodiment data check is carried out on the basis of the program stored in the data check program ROM 1115 by using the RAM 1102 constructed as mentioned above, even when there is no data check program ROM 1115, a check program may be previously incorporated in the program to be downloaded as in the fifth embodiment, whereby the same effect as mentioned above can be achieved.

As described above, in the semiconductor integrated circuit device according to the sixth embodiment of the present invention, since the check program for checking whether the rewrite program stored in the RAM 1106 is correctly stored or not is stored in the ROM 1115, even when errors occur during transfer or development of the check program, it is possible to easily and reliably check whether the rewrite program is correctly stored in the RAM 1106 or not.

Further, an area where the rewrite program is not stored is divided into two areas, and program data corresponding to ½ of the area where the rewrite program is not stored, and the same data as the program data read into the ½ area are successively read into the respective areas, and then an exclusive OR is obtained from the respective read data. This procedure is repeatedly carried out. Therefore, it is possible to check whether the rewrite program is correctly stored in the RAM 1106 or not. When the rewrite program is not correctly stored in the RAM 1106, information about a location where the rewrite program is not correctly stored in the RAM 1106 can be obtained.

Furthermore, an area where the rewrite program is not stored is divided into two areas, and program data corresponding to ½ of the area where the rewrite program is not stored, and data obtained by inverting the program data read into the ½ area are successively read into the respective areas, and then an AND is obtained from the respective read data. This procedure is repeatedly carried out. Therefore, it is possible to check whether the rewrite program is correctly stored in the RAM 1106 or not. Further, the judgement as to whether the program stored in the RAM 1106 is correct or not can be accurately carried out even when the output of the RAM 1106 becomes a fixed value due to a defect in the decryption circuit 1105 that occurs for some reason, and thereby data matching occurs when the exclusive OR is obtained, which makes it difficult to check whether the rewrite program is correctly stored in the second storage means or not.

In the semiconductor integrated circuit device according to any of the first to sixth embodiments of the present invention, the previously encrypted rewrite program is downloaded into the semiconductor integrated circuit. However, it is needless to say that the same effect as mentioned above can be achieved even when an unencrypted rewrite program is downloaded into the semiconductor integrated circuit.

### Embodiment 7

According to a seventh embodiment of the present invention, in a semiconductor integrated circuit device wherein a previously encrypted rewrite program is stored in a memory, after the encrypted rewrite program is decrypted and stored in a RAM, the rewrite program is again encrypted, and the re-encrypted program data is compared with the previously encrypted program data, in order to check whether the rewrite program as secret information not to be leaked to third parties is correctly stored or not.

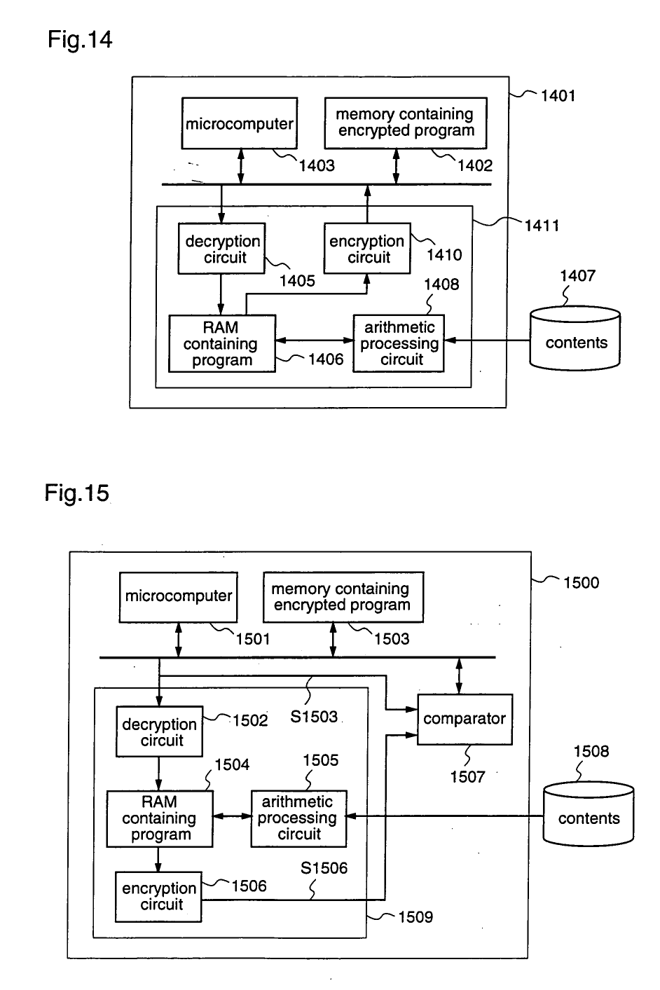

FIG. 14 is a diagram illustrating the structure of the semiconductor integrated circuit device according to the seventh embodiment of the present invention.

In FIG. 14, reference numeral 1401 denotes a semiconductor integrated circuit device having an encrypted rewrite program, 1402 denotes a memory (first storage means) in which the previously encrypted rewrite program is stored, and 1403 denotes a microcomputer for control. A semiconductor integrated circuit 1411 comprises a decryption circuit (decryption means) 1405 for deciding the encrypted rewrite program, a RAM (second storage means) 1406 for holding the rewrite program decrypted by the decryption circuit 1105, an arithmetic processing circuit (arithmetic processing unit) 1408 which is operated according to the control procedure of the decrypted program, and processes contents data 1407, and an encryption circuit (encryption means) 1410 for re-encrypting the data transferred to the RAM 1406.

Next, the operation of the semiconductor integrated circuit device 1401 thus constructed will be described.

Initially, the rewrite program that has previously been encrypted and stored in the memory 1402 is decrypted by the decryption circuit 1405 and stored in the RAM 1406 under control of the microcomputer 1403. When transfer of a predetermined amount of data, among the data stored in the memory 1402, has been completed, the rewrite program which has just been decrypted and stored in the memory 1406 is read to be re-encrypted by the encryption circuit 1410, and the re-encrypted program data is compared with the previously encrypted program data that is stored in the memory 1402, under control of the microcomputer 1403. When these data agree with each other, it is judged that the rewrite program which has initially been read from the memory 1402 and then decrypted by the decryption circuit 1405 and stored in the RAM 1406 is correct.

According to the seventh embodiment of the present invention, in the semiconductor integrated circuit device in which the previously encrypted program is downloaded into the semiconductor integrated circuit 1411, after the encrypted rewrite program is decrypted and stored in the RAM 1406, the rewrite program is again encrypted by the encryption circuit 1410, and the re-encrypted rewrite program is compared with the previously encrypted rewrite program. Therefore, it is possible to check whether the rewrite program stored in the RAM 1406 is correctly stored or not, without reading the rewrite program as secret information not to be leaked to third parties to the outside.

### Embodiment 8

In a semiconductor integrated circuit device according to an eighth embodiment of the present invention, when it is judged that a rewrite program stored in a RAM is incorrect, a portion of the rewrite program to be corrected is detected to correct the rewrite program.

Hereinafter, the semiconductor integrated circuit device according to the eighth embodiment of the present invention will be described with reference to FIGS. 15, 16, and 17.

FIG. 15 is a diagram illustrating the structure of the semiconductor integrated circuit device according to the eighth embodiment of the present invention, which enables correction of the program when it is judged that the program stored in the RAM is incorrect.

In FIG. 15, reference numeral 1500 denotes a semiconductor integrated circuit device in which an encrypted rewrite program is downloaded, 1503 denotes a memory (first storage means) in which the previously encrypted rewrite program is stored, and 1501 denotes a microcomputer for control. A semiconductor integrated circuit 1509 comprises a decryption circuit (decryption means) 1502 for decrypting the encrypted rewrite program, a RAM (second storage means) 1504 for holding the rewrite program decrypted by the decryption circuit 1502, an arithmetic processing circuit (arithmetic processing unit) 1505 which is operated according to the control procedure of the decrypted program, and processes contents data 1508, and an encryption circuit 1506 for again encrypting the rewrite program stored in the RAM 1504. The above-mentioned constituents are identical to those of the semiconductor integrated circuit device 1401 shown in FIG. 14. The semiconductor integrated circuit device 1500 further includes a comparator 1507 for comparing the output S1506 of the encryption circuit 1506 with the output S1503 of the memory 1503 in which the previously encrypted rewrite program is stored, and detects a position where the program is not correctly stored in the RAM 1504.

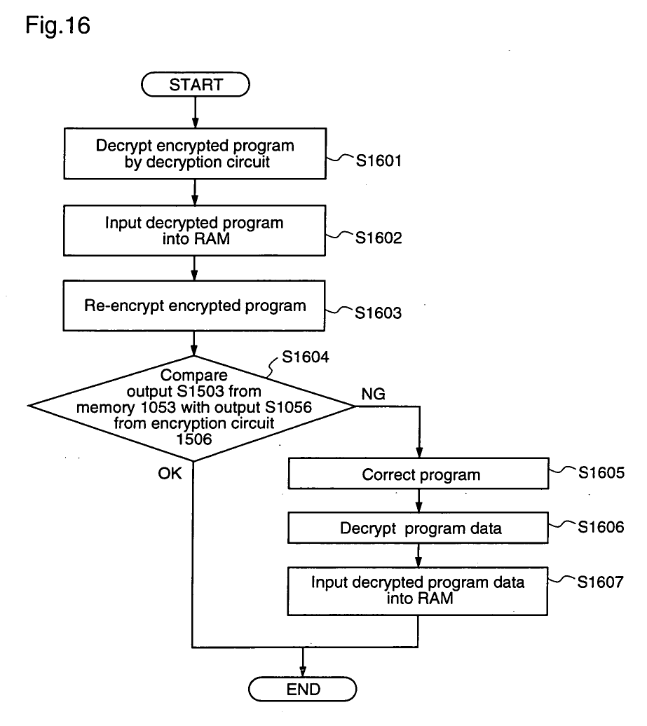

Hereinafter, the operation of the semiconductor integrated circuit device 1500 constructed as described above will be described. FIG. 16 shows an operation flow of the semiconductor circuit 1500 according to the eighth embodiment.

Initially, the encrypted rewrite program is decrypted by the decryption circuit 1502 (step S1601), and the decrypted rewrite program is input to the RAM 1504 according to the control microcomputer 1501 (step S1602). The rewrite program inputted to the RAM 1504 in step S1602 is again encrypted by the encryption circuit 1506 (step S1603), and the rewrite program encrypted in step S1603 is compared with the rewrite program stored in the memory 1503 (step S1604). When the result of the check in step S1604 is “incorrect”, the rewrite program is corrected so that the bits in the incorrect portion of the RAM are not used (step S1605). The program corrected in step S1605 is decrypted (step S1606), and the decrypted program is input to the RAM 1504 (step S1607).

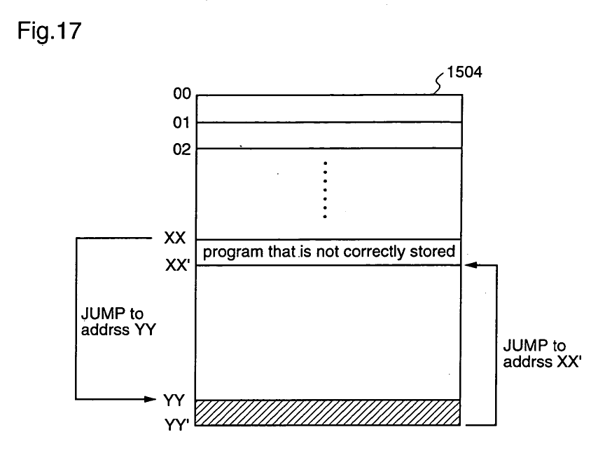

Further, the operation of correcting the rewrite program in step S1605 is carried out as follows. For example, as shown in FIG. 17, assuming that an incorrect portion of the rewrite program stored in the RAM 1504 ranges from an address XX to an address XX′ which is a predetermined unit such as a machine word unit, the data to be stored in the addresses XX to XX′ are stored as a correction program in addresses YY to YY′. At this time, a command program for jumping to the address YY when reading up to the address XX is completed, and a command program for jumping to the address XX′ when reading up to the address YY′ is completed are incorporated in the correction program. When correction is thus carried out, reading of the program stored in the RAM 1504 can be correctly carried out.

According to the above-mentioned method, after the corrected program is input to the RAM 1504, the program is read and checked, whereby the defective bits of the RAM 1504 are not used, resulting in efficient use of the RAM.

In this eighth embodiment, the output S1503 from the memory 1503 in which the previously encrypted rewrite program is stored is compared with the output S1506 from the encryption circuit 1506 for re-encrypting the decrypted rewrite program, and a position where the program is not correctly stored in the RAM 1504 is detected from the result of the comparison, and then the rewrite program is corrected. However, since the above-mentioned correction of the rewrite program is realized as long as the defect position in the RAM can be detected, it is also applicable to an example wherein an exclusive OR and an AND of the data which are read by the constructions of the memory and the RAM described for the sixth embodiment are obtained to be used for data check.

As described above, in the semiconductor integrated circuit device according to the eighth embodiment, when the result of the check as to whether the rewrite program is correctly stored in the RAM or not is that the program is not correctly stored in the RAM, the rewrite program is corrected so that the bits of the RAM in which data cannot be correctly written are not used, and the corrected program is downloaded to the RAM. Therefore, even when part of bits in the RAM are not correctly generated, data are written in other parts to correctly operate the rewrite program, whereby the RAM can be efficiently utilized.

While in the first to eighth embodiments of the present invention the rewrite program is stored in the memory (first storage means) and downloaded to the semiconductor integrated circuit, the rewrite program may be stored outside the semiconductor integrated circuit device and downloaded into the semiconductor integrated circuit using a communication means such as the Internet or the like. Also in this case, the same effect as mentioned above can be achieved.

Further, while in the first to eighth aspect of the present invention the semiconductor integrated circuit devices are described, a device corresponding to the semiconductor integrated circuit device may be a system which is equipped with a semiconductor integrated circuit having an externally non-accessible area (storage means), or it may be a data storage verification device (method) for verifying whether download of secret data into the non-accessible area (storage means) of the system has succeeded or not, with the same effects as described above.

Furthermore, it is needless to say that, in the semiconductor integrated circuit device according to the second to eighth embodiments, the RAM for holding the program may be an externally unreadable one.

### APPLICABILITY IN INDUSTRY

As described above, a semiconductor integrated circuit device, a data storage verification device, and a data storage verification method according to the present invention are able to check whether program data having confidentiality is correctly downloaded in a semiconductor integrated circuit without reading the data to the outside, and particularly, it is useful to check whether download of a program or the like to be protected by copyright has succeeded or not.

1. A semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents;
wherein said second storage means has an externally readable area that can be read from the outside of the semiconductor integrated circuit, and an externally unreadable area that cannot be read from the outside; and
after arbitrary data is stored in the externally readable area of the second storage means, the data is read to the outside of the semiconductor integrated circuit to check whether the arbitrary data is the data as inputted, and thereafter, the rewrite program read from the first storage means is stored in the externally unreadable area of the second storage means.

2. A semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents, said semiconductor integrated circuit device including:
a control circuit for performing control so as to read only a specific portion of the rewrite program stored in the second storage means.

3. A semiconductor integrated circuit device as defined in claim 2 wherein said control circuit performs control so as to read only the rewrite program located in specific addresses of the second storage means.

4. A semiconductor integrated circuit device as defined in claim 2 wherein said control circuit performs control so as to read only specific bits of the rewrite program stored in the second storage means.

5. A semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents;
wherein said rewrite program includes a program for executing a portion of the rewrite program after the rewriting; and
the portion of the rewrite program stored in the second storage means is executed.

6. A semiconductor integrated circuit device as defined in claim 5 wherein the portion of the rewrite program to be executed is one for successively executing discontinuous program areas.

7. A semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents; and
said semiconductor integrated circuit device including, in the semiconductor integrated circuit, a transfer monitor means for monitoring transfer errors of the rewrite program to be transferred from the first storage means to the second storage means.

8. A semiconductor integrated circuit device having a second storage means in a semiconductor integrated circuit, in which a program that makes an arithmetic processing unit in the semiconductor integrated circuit perform an operation of processing contents is rewritably stored, and performing rewriting of the program stored in the second storage means using a first storage means in which a rewrite program for rewriting is stored, which rewrite program makes the arithmetic processing unit perform an operation of processing the contents;
wherein the rewrite program includes a check program for checking whether the program is correct or not;
the semiconductor integrated circuit is provided with a work memory for the arithmetic processing unit, and a connection switching means for switching the connection between the second storage means or the work memory, and the program input or the data input of the arithmetic processing unit; and
the check program that is extracted from the rewrite program stored in the second storage means is stored in the work memory, and the arithmetic processing unit is operated by the check program stored in the work memory, thereby to check whether the rewrite program is correct or not.

9. A semiconductor integrated circuit device as defined in claim 8 wherein the second storage means holds the rewrite program, and holds data which is uniquely obtained from a predetermined cluster in the rewrite program, according to a predetermined rule.

10. A semiconductor integrated circuit device as defined in claim 9 wherein the uniquely obtained data is used as a check code for checking whether the program is correct or not.

11. A semiconductor integrated circuit device as defined in claim 8 wherein the second storage means has a construction in which an area where the rewrite program is not stored is successively divided into two areas, and the same program is stored in each of the two areas;
the check program includes
a program for comparing the program data stored in one of the two areas with the same data stored in the other area, thereby to check whether the program data is correct or not, and
a program for, when the result of the previous check is that the program data is correct, repeating an operation of further dividing one of the two areas, as an area wherein no program is stored, into two areas, and storing the same program data in each of the two areas; and
all of the programs to be stored in the second storage means are successively stored.

12. A semiconductor integrated circuit device as defined in claim 11 wherein the second storage means stores the rewrite program data, and data that is uniquely obtained from the program data according to a predetermined rule, in the two areas into which the area in the second storage means where the rewrite program is not stored is successively divided.

13. A semiconductor integrated circuit device as defined in claim 12 wherein the uniquely obtained data is inverted data of the program data.

14. A semiconductor integrated circuit device as defined in claim 8 further including a ROM (Read Only Memory) in which the check program is previously stored;
wherein the arithmetic processing unit is operated by the ROM to check whether the rewrite program is correct or not.

15. A semiconductor integrated circuit device as defined in claim 1 further including, in the semiconductor integrated circuit, a decryption means for decrypting the encrypted rewrite program;
wherein, when the rewrite program stored in the first storage means has previously been encrypted, the decryption means decrypts the encrypted program, and stores the decrypted rewrite program in the second storage means.

16. A semiconductor integrated circuit device having a second storage means in a semiconductor integrated circuit, in which a program that makes an arithmetic processing unit in the semiconductor integrated circuit perform an operation of processing contents is rewritably stored, and performing rewriting using a first storage means in which a previously encrypted rewrite program for rewriting is stored, which rewrite program makes the arithmetic processing unit perform an operation of processing the contents;
said semiconductor integrated circuit device including, in the semiconductor integrated circuit,
a decryption means for decrypting the encrypted rewrite program read from the first storage means, and transferring the decrypted rewrite program to the second storage means; and
an encryption means for again encrypting the rewrite program stored in the second storage means;
wherein the rewrite program encrypted by the encryption means is compared with the encrypted rewrite program stored in the first storage means.

17. A semiconductor integrated circuit device as defined in claim 11 wherein, when data are not correctly stored in the second storage means, a defective portion is detected, and the rewrite program stored in the first storage means is corrected.

18. A semiconductor integrated circuit device as defined in claim 1 wherein the rewrite program that is stored outside the semiconductor integrated circuit device is downloadable into the semiconductor integrated circuit.

19. A data storage verification device comprising:
means for storing arbitrary data in a storage means having an area which is accessible from the outside;
means for outputting the arbitrary data to the outside, and judging whether the arbitrary data is correctly stored or not; and
means for storing secret data in a storage means having an area which is inaccessible from the outside, when it is judged that the arbitrary data is correctly stored.

20. (canceled)

21. (canceled)

22. A data storage verification device comprising:
first means for storing secret data including an inspection program and a secret program into a storage means having an area which is inaccessible from the outside;
second means for executing the inspection program, and outputting the result to the outside; and
third means for executing the secret program after completion of the second means.

23. A data storage verification device comprising:
means for storing secret data in a storage means having an area which is inaccessible from the outside;
means for performing a predetermined arithmetic operation using the secret data, simultaneously with the storage; and
means for outputting the result of the arithmetic operation to the outside.

24. A data storage verification device comprising:
fourth means for storing secret data in a storage means having a first area which is inaccessible from the outside;
fifth means for storing an inspection program which is a part of the secret data and is stored in the first area, into a storage means having a second area; and
sixth means for executing the inspection program stored in the second area to verify correctness of the secret data stored in the first area.

25. A data storage verification device as defined in claim 24 further including seventh means for transferring control to a command of the first area after completion of the sixth means.

26. A data storage verification device as defined in claim 24 wherein the fifth means executes storage of the inspection program according to a command that exists in the secret data stored in the first area.

27. A data storage verification device as defined in claim 24 wherein the fifth means executes the inspection program according to a command that has been stored in a third area before execution of storage by the fourth means.

28. A data storage verification device comprising:
means for decrypting secret data;
means for storing the decrypted data in a storage means having an area which is inaccessible from the outside;
means for encrypting the stored data; and
means for comparing the encrypted data with the secret data to judge whether the stored data is correctly stored or not.

29. (canceled)

30. A data storage verification method comprising:
step of storing arbitrary data in a storage means having an area which is accessible from the outside;
step of outputting the arbitrary data to the outside, and judging whether the arbitrary data is correctly stored or not; and
step of storing secret data in a storage means having an area which is inaccessible from the outside, when it is judged that the arbitrary data is correctly stored.

31. (canceled)

32. (canceled)

33. A data storage verification method comprising:
first step of storing secret data including an inspection program and a secret program into a storage means having an area which is inaccessible from the outside;
second step of executing the inspection program, and outputting the result to the outside; and
third step of executing the secret program after completion of the second step.

34. A data storage verification method comprising:
step of storing secret data in a storage means having an area which is inaccessible from the outside;
step of performing a predetermined arithmetic operation using the secret data, simultaneously with the storage; and
step of outputting the result of the arithmetic operation to the outside.

35. A data storage verification method comprising:
fourth step of storing secret data in a storage means having a first area which is inaccessible from the outside;
fifth step of storing an inspection program which is a part of the secret data and is stored in the first area, into a storage means having a second area; and
sixth step of executing the inspection program stored in the second area to verify correctness of the secret data stored in the first area.

36. A data storage verification method as defined in claim 35 further including seventh step of transferring control to a command of the first area after completion of the sixth step.

37. A data storage verification method as defined in claim 35 wherein the fifth step executes storage of the inspection program according to a command that exists in the secret data stored in the first area.

38. A data storage verification method as defined in claim 35 wherein the fifth step executes the inspection program according to a command that has been stored in a third area before execution of storage in the fourth step.

39. A data storage verification method comprising:
step of decrypting secret data;
step of storing the decrypted data in a storage means having an area which is inaccessible from the outside;
step of encrypting the stored data; and
step of comparing the encrypted data with the secret data to judge whether the stored data is correctly stored or not.

40. (canceled)

41. A semiconductor integrated circuit device as defined in claim 2 further including, in the semiconductor integrated circuit, a decryption means for decrypting the encrypted rewrite program;
wherein, when the rewrite program stored in the first storage means has previously been encrypted, the decryption means decrypts the encrypted program, and stores the decrypted rewrite program in the second storage means.

42. A semiconductor integrated circuit device as defined in claim 5 further including, in the semiconductor integrated circuit, a decryption means for decrypting the encrypted rewrite program;
wherein, when the rewrite program stored in the first storage means has previously been encrypted, the decryption means decrypts the encrypted program, and stores the decrypted rewrite program in the second storage means.

43. A semiconductor integrated circuit device as defined in claim 7 further including, in the semiconductor integrated circuit, a decryption means for decrypting the encrypted rewrite program;
wherein, when the rewrite program stored in the first storage means has previously been encrypted, the decryption means decrypts the encrypted program, and stores the decrypted rewrite program in the second storage means.

44. A semiconductor integrated circuit device as defined in claim 8 further including, in the semiconductor integrated circuit, a decryption means for decrypting the encrypted rewrite program;
wherein, when the rewrite program stored in the first storage means has previously been encrypted, the decryption means decrypts the encrypted program, and stores the decrypted rewrite program in the second storage means.

45. A semiconductor integrated circuit device as defined in claim 16 wherein, when data are not correctly stored in the second storage means, a defective portion is detected, and the rewrite program stored in the first storage means is corrected.

46. A semiconductor integrated circuit device as defined in claim 2 wherein the rewrite program that is stored outside the semiconductor integrated circuit device is downloadable into the semiconductor integrated circuit.

47. A semiconductor integrated circuit device as defined in claim 5 wherein the rewrite program that is stored outside the semiconductor integrated circuit device is downloadable into the semiconductor integrated circuit.

48. A semiconductor integrated circuit device as defined in claim 7 wherein the rewrite program that is stored outside the semiconductor integrated circuit device is downloadable into the semiconductor integrated circuit.

49. A semiconductor integrated circuit device as defined in claim 8 wherein the rewrite program that is stored outside the semiconductor integrated circuit device is downloadable into the semiconductor integrated circuit.

50. A semiconductor integrated circuit device as defined in claim 16 wherein the rewrite program that is stored outside the semiconductor integrated circuit device is downloadable into the semiconductor integrated circuit.
